(19) United States
(12) Patent Application Publication
(10) Pub. No.: US 2010/0058240 A1
(43) Pub. Date: Mar. 4, 2010

(54) Dynamic Control of List Navigation Based on List Item Properties

(75) Inventors: William Bull, Mountain View, CA (US); Policarpo Wood, San Francisco, CA (US); Kourtny Minh Hicks, Sunnyvale, CA (US); Benjamin Andrew Rottler, Burlingame, CA (US); Eric James Hope, Cupertino, CA (US); Alan Cannistraro, San Francisco, CA (US)

Correspondence Address: TOWNSEND AND TOWNSEND AND CREW, LLP, TWO EMBARCADERO CENTER, 8TH FLOOR, SAN FRANCISCO, CA, 94111-3834, US

(73) Assignee: Apple Inc., Cupertino, CA (US)

(21) Appl. No.: 12/198,797

(22) Filed: Aug. 26, 2008

(51) Int. Cl. G06F 3/048

(52) U.S. Cl. 715/830

(57) ABSTRACT

Navigating or scrolling through a list of items is enhanced by assigning a given item a non-null value for a friction property, and slowing the scrolling when the given item nears or enters the viewport, or pausing the scrolling when the given item enters the viewport. Scrolling at speed can be configured to be resumed when the user takes a particular action, or can be configured to resume after a designated elapsed time without user action. At least to the extent that scrolling through the list is accompanied by sequential items being at a cursor position within the viewport, the scrolling can slow down or pause when the given item is within a predetermined number of list items from the cursor position.

### BACKGROUND OF THE INVENTION

The present invention relates generally to information display and more particularly to scrolling through items on a list such as a list of media assets.

Media assets, such as audio tracks, video tracks, or images (e.g., photos) can be stored, displayed, and/or played on a portable media device (“PMD”) or on a host computer executing a media management application (“MMA”). Often, a portable media device acquires its media assets from a host computer executing an MMA, and the user may use the MMA to organize the collection of media assets. One example of a PMD may be the IPod® PMD, currently available from Apple Inc. of Cupertino, Calif. One example of an MMA may be the iTunes® MMA, produced by Apple Inc. Some PMDs provide the user a display to aid in interacting with the content on the PMD.

The large numbers of stored tracks that can be available on a PMD and/or on a host computer executing a MMA can create a substantial navigation and management challenge for the user and the manufacturer alike. While the host computer is typically provided with a significantly larger display than the PMD, navigation within the MMA can still be a significant problem. Even a large display provides a viewport that covers a small fraction of a very long list. Thus, regardless of the portability of the device and the size of its display, list navigation can create challenges.

Navigating or scrolling through a list has at least the following two related aspects, either or both of which can be in play at a given time:
(1) The list and a viewport are moved relative to one another, and the issue is which list items are currently displayed, i.e., which items are within the viewport. It is assumed that the viewport is too small to display the entire list at once.
(2) The list and a cursor are moved relative to each other, and the issue is which of the items is at the cursor position. When an item is at the cursor position, the item is capable of having an action invoked on it.

In situations where the viewport aspect alone is in play, the cursor position (if applicable at all) does not change when the list and the viewport are moved relative to each other. From the user's point of view, the list is what is moving. Examples of this are various file browsers, word processing applications, database programs, calendar programs, and MMAs such as iTunes®, where the window can be scrolled independently of whether there are any selected items. This type of scrolling typically involves the user interacting with a displayed scroll bar along an edge of the window, activating a scrolling mechanism such as a scroll wheel on a pointing device, or performing certain gestures on a trackpad or touchscreen.

In other situations, the initial state has the cursor aspect alone in play. From the user's point of view, the cursor position is what is moving. The viewport and list remain stationary relative to one another as the cursor moves from the first item in the viewport to the last item. However, the viewport begins to move relative to the list when the cursor can no longer move to the next item, which is hidden, and so the viewport aspect becomes in play as successive items move into the viewport. From the user's point of view at this point, the cursor is stopped at the leading edge of the viewport, and the list is what is moving through the cursor position into the viewport. Examples include some PMDs, and many of the same programs mentioned above, in scenarios where the cursor (selected item) is moved using the arrow keys or another mechanism that is separate from the mechanism that is used to scroll a window.

### SUMMARY OF THE INVENTION

Embodiments of the present invention provide user interfaces that can facilitate navigation or scrolling through lists of items, especially long lists. In many instances, the number of media assets that can be stored in a PMD is limited only by the capacity of the PMD's storage medium. In order to provide a possible context for the possible scope of the problem, one current model of Apple Inc. 's iPod® PMD has 160 GB of storage. If a typical MP3 track is on the order of 3-4 MB, this can translate to on the order of 40,000 tracks.

As mentioned above, navigating or scrolling through a list can entail one or both of moving a viewport relative to the list and moving a cursor position relative to the list. In either case, the list can be considered to be moving relative to a reference position. In the case of the viewport, the reference position can be the leading edge of the viewport, and the item that has just entered the viewport can be considered to be at the reference position. In the case of the cursor position, the reference position can be the cursor position, and the selectable item can be considered to be at the reference position. For some purposes, the reference position can be at a known offset from the edge of the viewport or the cursor position, as the case may be.

The terminology of scrolling through a list is used to cover both these aspects unless the context dictates otherwise. From the user's point of view, the desired aim is to traverse the list until the desired or relevant item is displayed and/or the desired or relevant item is at the cursor position. At the highest level, scrolling is achieved by converting a user input to an electrical signal, referred to as a scrolling request, and then mapping the scrolling request to a scroll control. The user input can be provided by action on a user interface device, for example, by one or more of a gesture on a plurality of capacitive sensors, and/or an actuation of a movable element, and/or a manipulation of a displayed control element, which can be provided by a GUI engine.

Embodiments of the present invention designate one or more given items in the list as having what might be thought of as friction, stickiness, or added mass. When an item has friction (i.e., is a “frictional” item), and satisfies a proximity constraint with respect to the reference position, the default mapping of scrolling requests to scrolling control signals is overridden (modified) and an override mapping is used. The override mapping can operate so that scrolling slows down or pauses when the user is scrolling through the list and would otherwise pass by the given item.

The proximity constraint can be a requirement that a frictional item be within a given number of items of the reference position. However, in some embodiments, the proximity constraint can be that the frictional item lies within a given range of one side of the reference position. The particular distance can differ depending on the speed of scrolling, and the proximity constraint can differ for different kinds of frictional items.

In this context default scrolling (i.e., scrolling using the default mapping) includes whatever scrolling behavior results from the user's interaction with the user interface elements that control scrolling. Thus the default scrolling can be very fast or very slow depending on the user's activities. The default scrolling can be at constant speed, or at a variable speed (for example, a speed that automatically increases with time in the absence of a user interaction to interrupt the scrolling).

Embodiments of the invention override (modify) this so-called default behavior, and the nature of the modification can be tailored to take the default scrolling speed profile into account. As one example, the modification can be reduced or disabled for scrolling speeds below a specified threshold. Further, the nature of the modification can be tailored to take the length of the list into account. As one example, the modification can be reduced or disabled for lists containing fewer than a specified threshold number of items.

In an aspect of the invention, a method of controlling the display of a list of items in response to a scrolling request comprises: converting the scrolling request to a scrolling control signal using a default mapping so that items on the list move relative to a reference position with a speed profile and direction determined by the default mapping; and in response to determining that a given item on the list has friction and that the given (frictional) item and the reference position satisfy a proximity constraint, overriding the default mapping and converting the scrolling request to a scrolling control signal using an override mapping so that items on the list move relative to the reference position with a lower speed than otherwise specified by the default mapping.

In another aspect of the invention, a method of controlling the display of a list of items in response to a scrolling request comprises: scrolling through the list so that items on the list move relative to a reference position with a speed profile and direction determined by a default mapping of the scrolling request, at least some items on the list moving toward, and then past the reference position; determining that a given item on the list has friction; and overriding the default mapping when the given (frictional) item and the reference position satisfy a proximity constraint so that scrolling occurs with a lower speed than otherwise specified by the default mapping.

In another aspect of the invention, a method of controlling the display of a list of items in response to a scrolling request comprises: converting the scrolling request to a scrolling control signal using a default mapping so that items on the list move relative to a cursor position with a speed profile and direction determined by the default mapping; and in response to determining that a given item on the list has friction and that the given (frictional) item is at or near the cursor position, overriding the default mapping and converting the scrolling request to a scrolling control signal using an override mapping so that items on the list move relative to the cursor position with a lower speed than otherwise specified by the default mapping.

In another aspect of the invention, a method of controlling the display of a list of items in response to a scrolling request comprises: converting the scrolling request to a scrolling control signal using a default mapping so that items on the list move relative to a viewport with a speed profile and direction determined by the default mapping; and in response to determining that a given item on the list has friction and that the given (frictional) item appears in the viewport or is about to appear in the viewport, overriding the default mapping and converting the scrolling request to a scrolling control signal using an override mapping so that items on the list move relative to the cursor position with a lower speed than otherwise specified by the default mapping.

In another aspect of the invention, a portable device comprises: a storage medium; a processor coupled to the storage medium; a user interface element operable by a user to provide signals representing scrolling requests; and computer code stored in the storage medium. The computer code, when retrieved from the storage medium and executed by the processor, results in: displaying a list of items; converting the scrolling request to a scrolling control signal using a default mapping so that items on the list move relative to a reference position with a speed profile and direction determined by the default mapping; and in response to determining that a given item on the list has friction and that the given item and the reference position satisfy a proximity constraint, overriding the default mapping and converting the scrolling request to a scrolling control signal using an override mapping so that items on the list move relative to the reference position with a lower speed than otherwise specified by the default mapping.

In another aspect of the invention, apparatus for controlling the display of a list of items in response to a scrolling request comprises: a storage medium; a user interface element operable by a user to provide signals representing scrolling requests; a list display engine for displaying a list and moving the list relative to a reference position in response to a scrolling control signal; and a scrolling engine, responsive to scrolling requests, for converting a scrolling request to a scrolling control signal. The scrolling engine is configured to: convert the scrolling request to a scrolling control signal using a default mapping so that items on the list move relative to a reference position with a speed profile and direction determined by the default mapping; and in response to determining that a given item on the list has friction and that the given item and the reference position satisfy a proximity constraint, override the default mapping and convert the scrolling request to a scrolling control signal using an override mapping so that items on the list move relative to the reference position with a lower speed than otherwise specified by the default mapping.

In other aspects of the invention, a computer-readable medium contains program instructions, which when executed by a computer system in a portable device cause the computer system to execute a method of controlling the scrolling of a list of items on an output device wherein user input requesting scrolling, referred to as a scrolling request, is converted to a scrolling control signal. In these aspects of the invention, the method can be one of the methods described above in connection with other aspects of the invention.

In embodiments relating to any of the above methods, apparatus, or computer-readable media, overriding the default mapping can include pausing scrolling when the given item is at the reference position or at a position offset from the reference position. Overriding the default mapping can also include slowing scrolling at least before or after pausing scrolling (i.e., before pausing scrolling and/or after pausing scrolling).

In embodiments relating to any of the above methods, apparatus, or computer-readable media, where the reference position is defined by a cursor location, the proximity constraint can be that the given item is within a predetermined range that includes positions leading up to the cursor and positions past the cursor.

In embodiments relating to any of the above methods, apparatus, or computer-readable media, where the reference position is defined by the leading edge of a viewport, the proximity constraint can be that the given item is at the leading edge of the viewport or within the viewport, in which case whereupon the default mapping is first overridden when the given item enters the viewport and scrolling reverts to using the default mapping when the given item leaves the viewport. Alternatively, the proximity constraint can be that the given item be within a predetermined range of positions that includes at least one position within the viewport, and does not include the reference position, in which case the default mapping is first overridden after the given item has entered and traversed a portion of the viewport. Alternatively, the proximity constraint can be that the given item is within a predetermined range of positions that includes the reference position, at least one position within the viewport, and no positions outside the viewport, in which case the default mapping is first overridden when the given item enters the viewport. Alternatively, the proximity constraint can be that the given item is within a predetermined range of positions that includes at least one position leading up the reference position and one position past the viewport, in which case the default mapping is first overridden before the given item enters the viewport and scrolling reverts to using the default mapping after the given item has left the viewport.

In embodiments relating to any of the above methods, apparatus, or computer-readable media, where the reference position is defined by the leading edge of a viewport, the default mapping can be overridden so that the given item remains in the viewport for at least a predetermined time before relative movement resumes according to the default mapping. Alternatively, the default mapping can be overridden so that the given item is paused in the viewport for at least a predetermined time before relative movement resumes according to the default mapping. Alternatively, the default mapping can be overridden so that the given item moves at a significantly reduced speed across at least a portion of the viewport before relative movement resumes according to the default mapping. Alternatively, the speed profile can be overridden so that the given item's speed is reduced when the given item first appears in the viewport. Alternatively, the default mapping can be overridden so that the speed of items in the viewport is reduced before the given item first appears in the viewport, and relative movement resumes according to the default mapping after the given item has remained in the viewport for at least a predetermined time.

In embodiments relating to any of the above methods, apparatus, or computer-readable media, the frictional item's appearance can be changed relative to adjacent items. Changing the appearance of the frictional item can include at least one of leaving additional space between the given item and one or more adjacent items, putting a border around the given item, changing a text style of the given item, applying an animation feature to the given item, or providing a 3 D aspect for the given item. Alternatively, or in addition to any of the above, the frictional item can be displayed with additional information regarding the frictional item, either instead of or in addition to, information that is displayed for other items on the list. The additional information can be text or graphical information.

The invention is not limited to any particular way of designating an item as having friction. For example, it is possible to define a friction property and to designate an item as frictional by changing a default (null) value signifying no friction to a non-null value for that item. Further, there is no requirement that the friction be limited to being present or absent; the friction property may be defined to have multiple possible non-null values. Further, while the friction value can be incorporated into an item's metadata, this is not necessary. For example, embodiments of the present invention can be implemented by keeping a list of items having friction.

Given items may be designated as frictional automatically or may be designated by the user. The criteria for automatically designating frictional items can be themselves controlled by the user as a stored preference. For example, in an alphabetized list, the respective first items in the groups starting with the same letter could be assigned a high friction value. The presence or absence of friction can be context-sensitive; for example, an item beginning with a given letter may or may not be frictional, depending on which other items beginning with that letter are in the list.

While specific embodiments deal with portable media devices (“PMDs”) and media management applications (“MMAs”) where the items are media assets stored on, or otherwise available or retrievable to, the PMD or MMA, the invention is not limited to such environments. Other types of application programs and file browsers executing on a general purpose computer represent but a small sample of environments that might present very long lists through which a user may need to navigate. Further, the enhanced navigation techniques can be useful for audiobook navigation.

A further understanding of the nature and advantages of the present invention may be realized by reference to the remaining portions of the specification and the drawings.

### BRIEF DESCRIPTION OF THE DRAWINGS

FIG. 1A is a block diagram of a device according to an embodiment of the present invention;

FIGS. 1B-1E are block diagrams showing different ways that the elements of FIG. 1A can be configured in separable modules;

FIG. 2A is a front view of a portable media device (“PMD”) or similar device, and further includes a balloon view of media asset information and scrolling information (list items and friction) that can be stored in the PMD according to an embodiment of the present invention;

FIG. 2B is a top view of the PMD shown in FIG. 2A;

FIG. 2C is a bottom view of the PMD shown in FIG. 2A;

FIG. 3 is a schematic view of a list to be scrolled and a viewport within which a small portion of the list can be displayed at any given moment;

FIG. 4 is a block diagram of elements that provide scrolling control according to an embodiment of the present invention;

FIGS. 5A-5F show different ways for visually differentiating frictional items from their neighbors;

FIGS. 6A, 6B, and 6C are plots of height of the frictional item in the viewport as a function of time, scrolling speed of the frictional item as a function of height in the viewport, and scrolling speed of the frictional item as a function of time, respectively, for a default mapping of scrolling request signals;

FIGS. 7A, 7B, and 7C are corresponding plots for an embodiment of the present invention where the scrolling speed is reduced during the entire time that the frictional item is in the viewport;

FIGS. 8A, 8B, and 8C are corresponding plots for an embodiment of the present invention where the scrolling speed is reduced during an interval before the frictional item enters the viewport, during the entire time that the frictional item is in the viewport, and during an interval after the frictional item leaves the viewport;

FIGS. 9A, 9B, and 9C are corresponding plots for an embodiment of the present invention where the scrolling speed is reduced during a portion of the time that the frictional item is in the viewport;

FIGS. 10A, 10B, and 10C are corresponding plots for an embodiment of the present invention where the scrolling speed is reduced to zero (i.e., scrolling pauses) during a portion of the time that the frictional item is in the viewport;

FIGS. 11A, 11B, and 11C are corresponding plots for another embodiment of the present invention where the scrolling speed is reduced to zero (i.e., scrolling pauses) during a portion of the time that the frictional item is in the viewport;

FIG. 12 is a flowchart showing operation in accordance with an embodiment of the present invention; and

FIG. 13 is a block diagram of a specific implementation of a device according to an embodiment of the present invention.

### DESCRIPTION OF SPECIFIC EMBODIMENTS

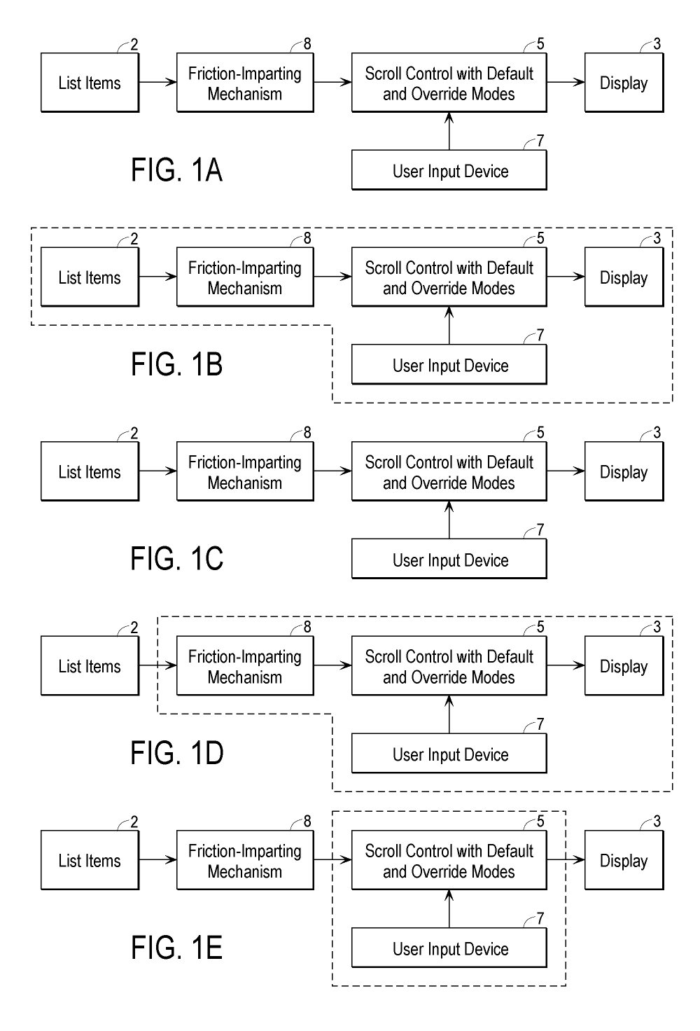

FIG. 1A is a block diagram of a device according to an embodiment of the present invention that provides enhancements to the scrolling of lists. A set of list item data 2 is processed to generate a list of list items to be scrolled on a display 3. A scroll control mechanism 5 operates on the list item data to determine the scrolling characteristics. Scroll control mechanism 5 receives user input from a user input device 7. A broad range of user input devices will be described below.

In accordance with embodiments of the present invention, certain items on the list to be scrolled are provided with what is referred to as friction, and scrolling is overridden (modified) for such items. A list item having a non-null friction value is referred to as a “frictional” item. This is shown schematically as a friction-imparting mechanism 8 between list item data 2 and scroll control mechanism 5, and further by scroll control mechanism 5 having default and override modes.

Scroll control mechanism maps signals from user input device 7 to scrolling control signals, and the manner in which the mapping occurs is overridden depending on the positions of frictional items relative to a reference position. As mentioned above, and will be discussed in detail below, the default scrolling mode is overridden when a frictional item satisfies a proximity constraint with respect to the reference position. In some examples, the reference position is the leading edge of the viewport; in other examples the reference position is a cursor position.

For example, the speed of scrolling can be selectively slowed when frictional items appear or are about to appear in the viewport; alternatively or in addition, scrolling can be paused when frictional items appear in the viewport. The assignment of friction can be accomplished in advance or dynamically during scrolling. In some examples, a user assigns friction to items of relatively high interest (a subjective determination). In some examples, the system infers which items are likely to be of higher interest than others (e.g., most frequently accessed items and/or most recently accessed items). The characteristics of the override scrolling vis-ä-vis the default scrolling can be set by the user and/or by the system automatically. The override characteristics can also be modified dynamically (for example, based on such factors as the default scrolling speed or the length of the list).

FIGS. 1B-1E replicate the elements of FIG. 1A, but show different ways that the elements of FIG. 1A can be configured in separable modules. These figures thus provide examples of how embodiments of the present invention can be deployed in different environments. In different examples, different combinations of elements are referred to as being tightly associated. This can be taken to mean that the elements share a common housing, or are connected with cables or the like in a manner that they are intended to remain connected for extended periods of time. In all these examples, a statement that user input device 7 is tightly associated with scroll control mechanism 5 should be taken to include the possibility that user input device 7 is on a remote control that communicates with scroll control mechanism 5.

FIG. 1B shows a configuration where all the elements are tightly associated. Examples of this topology include portable and non-portable devices and computers that have built-in displays and have provisions for storing list data internally (possibly in removable media). In examples where the list items are associated with media assets, such as audio tracks, video tracks, or images (e.g., photos), the devices can include media players.

FIG. 1C shows a configuration where display 3 is less tightly associated with the remaining elements, for example where list item data 2, friction-imparting mechanism 8, scroll control mechanism 5, and user input device 7 are tightly associated, and the list is displayed on an external display. Examples of this topology include portable and non-portable devices. In examples where the list items are associated with media assets, such as audio tracks, video tracks, or images (e.g., photos), the devices can include media players and set-top boxes.

FIG. 1D shows a configuration where list item data 2 is less tightly associated with the remaining elements, for example where friction-imparting mechanism 8, scroll control mechanism 5, display 3, and user input device 7 are tightly associated, and the source of list items is outside. An example of this topology is a portable or non-portable browser that scrolls through lists of items that come from outside. In examples where the list items are associated with media assets, such as audio tracks, video tracks, or images (e.g., photos), the devices can include media players.

FIG. 1E shows a configuration where list item data 2, friction-imparting mechanism 8, and display 3 are less tightly associated with the remaining elements, for example where scroll control mechanism 5 and user input device 7 are tightly associated. Examples are discrete systems and computers where the enhanced scroll control is a stand-alone accessory.

The possibilities shown in FIGS. 1B-1E underscore the fact that embodiments of the present invention can be deployed in a wide variety of environments. While much of the description refers to a portable device such as a portable media device (“PMD”) where the list items are media assets, there is no need to consider the invention to be limited to portable devices, much less PMDs. Rather, embodiments of the present invention can find applicability to any device or system that is capable of displaying a list and scrolling through the list in response to user input.

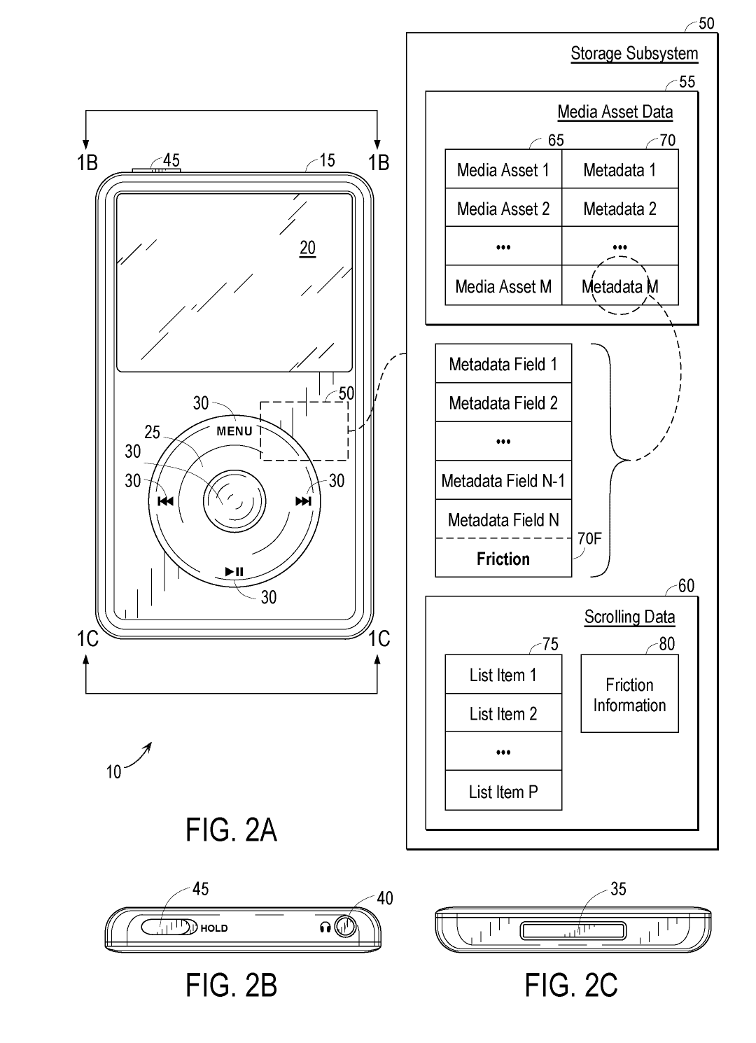

FIGS. 2A, 2B, and 2C are respective front, top, and bottom views of a PMD 10 or similar device according to an embodiment of the present invention. For concreteness, the description of PMD 10 will be in terms of a device that, among other things, plays music. PMDs such as Apple's iPod® devices are examples of devices in which embodiments of the present invention can be implemented. Components of PMD 10 may be hidden inside, or visible from outside, a housing 15.

Components disposed outside the housing or disposed to be visible outside the housing can include a display 20, one or more user input devices such as a scroll wheel 25 and buttons 30, one or more I/O connectors such as an accessory interface connector 35 and an audio out connector 40, and one or more switches such as a hold switch 45. The specific PMD includes four buttons denoted by respective text or graphical legends (“Menu”, Play/Pause, Forward, Backward), and a fifth button, which is not marked and can be used for selecting items. In the context of an iPod® device, scroll wheel 25 and buttons 30 are collectively referred to as a “click wheel.” These components communicate with circuitry and components (not generally shown in FIG. 2A) that are disposed inside housing 15. Included among the components disposed inside housing 15 is a storage subsystem 50 (shown in phantom).

Also shown in FIG. 2A is a balloon view of a portion of the data stored in storage subsystem 50. In the specific embodiment of a PMD, media assets can be stored in storage subsystem 50, and are shown schematically in FIG. 2A's balloon view of storage subsystem as a media asset data structure 55. In accordance with various embodiments of the present invention, certain information pertaining to scrolling of lists of media assets can also be stored in storage subsystem 50 and is shown in FIG. 2A's balloon view as a scrolling data structure 60. These data structures and their respective data will be described in greater detail below. Embodiments of the present invention can enhance the scrolling of lists of media assets (or other items) that are stored in PMD 10 and shown on display 20.

While a specific PMD is shown in FIGS. 2A, 2B, and 2C, the drawing could also have been drawn as a black box with a screen and an input device with which a user interacts to invoke scrolling. The details of PMD 10 beyond this are exemplary of a particular class of devices that can benefit from embodiments of the present invention.

Media assets are sometimes referred to simply as assets. The term “asset” can be broader in some contexts, including for example contacts, appointments, or descriptions of personal possessions. It is contemplated that the assets may change from time to time. Media asset data structure 55 is shown schematically as including one or more media assets 65 (shown with indices 1 . . . M) having associated sets of metadata 70 (shown with indices 1 . . . M). It is noted that in the case where the assets are contacts or the like, the distinction between asset and metadata blurs.

Media assets 65 can include any type of media content that can be stored in digital form and experienced by a user. Examples include songs, podcasts, audiobooks, video clips, movies, recorded television or radio broadcasts, photographs, slide shows, other still images, and so on. Where the media assets include music, the individual items are sometimes referred to as “tracks” and certain pre-defined collections of tracks are sometimes referred to as “albums.” User-defined collections of tracks are sometimes referred to as “playlists.”

Metadata 70 can include any data descriptive of one or more characteristics of that asset. For instance, metadata 70 may include inherent attributes of the asset as well as attributes taken on during the time after the asset is first stored in the PMD. The set of metadata is shown in an expanded version as a set of metadata fields (shown with indices 1 . . . N).

Again, in the context of music tracks and albums, examples of inherent (although possibly changeable by the user) metadata for an asset stored in the PMD can include media type (e.g., music, video, photo, audiobook, podcast, etc.), track ID, track number, track count, track name, artist, album, genre and sub-genre classification, digital encoding information (encoding algorithm, bit rate, sample rate), size, total time, date modified, date added, persistent ID, track type, file type, file creator, location. Some of the metadata may have been generated at the time of encoding the media asset itself and may be stored in the media asset file and made available for asset management applications.

Examples of metadata that can be specified by the user, or automatically created and updated based on user actions include user-supplied rating, playlist(s) to which the user has assigned the asset, play count, play date, play date UTC.

It is noted that in the case where the assets are themselves data items such as contacts or the like, the distinction between asset and metadata blurs. For media assets such as music or image files that are not numerical or alphanumeric, the metadata can include separate numerical and alphanumeric information about that asset. For an asset such as a contact in a contact database, it may be that there is no distinction between the metadata and the asset.

Although each media asset and its associated metadata are shown adjacent each other as if each asset/metadata pair formed a record in a flat-file database, other arrangements for associating assets and metadata can be used. For example, the iTunes® media management application (“MMA”) stores the music tracks as individual files in a hierarchical directory structure and the metadata as a single database file, presumably with pointers to the music tracks. Regardless of the structure of the metadata and assets, there is no fundamental reason that every asset have values for all types of metadata. That is, the structure of the metadata for like assets need not be the same for all the assets.

Scrolling data structure 60 is shown schematically as including a list 75 having one or more list items (shown with indices 1 . . . P). The list is shown as having associated friction information 80. As mentioned above, in accordance with embodiments of the present invention, a friction property is associated with the assets in the sense that some of the assets, at least when they appear in a list that is scrolled, have a non-null friction value attributed to them. That is, they become frictional. The friction property, which will be explained in detail below, is used to override the default scrolling behavior of lists of assets.

Friction is a property that may be persistently or transitorily associated with selected assets, and as such it may be convenient in some instances to store friction information in association with media asset data structure 55. An association of the friction property with the metadata is shown as if it were a separate metadata field, designated 70F (shown in bold for emphasis). In other instances, however, it may be convenient to store friction information in association with scrolling data structure 60, and that is shown schematically as friction information 80 being a part of scrolling data structure 60. It may also be convenient to store some or all of the friction information in association with both data structures.

There are many ways to organize friction information 80. In one example, the friction information can be organized as a set of friction values corresponding to the set of list items (i.e., with corresponding indices 1 . . . P). In another example, scrolling data structure 60 can contain only a list of indices for those list items having a non-null value for the friction property.

As mentioned above, while metadata 70 is shown as having a field 70F for a friction value, the friction value does not have to be an inherent part of the metadata for the media assets. Rather, as some examples will show, the friction can be associated with media assets only when they appear in a list, or even only when the list is to be scrolled. In other implementations, the user can specify that a given set of media assets should be assigned a friction value whenever they are in a list being scrolled, in which case the friction is persistently associated with the asset. Even then, however, this can be implemented by maintaining, in scrolling data structure 60 for example, a list of media assets that have a friction value, in which case the friction values need not become part of media asset data structure 55.

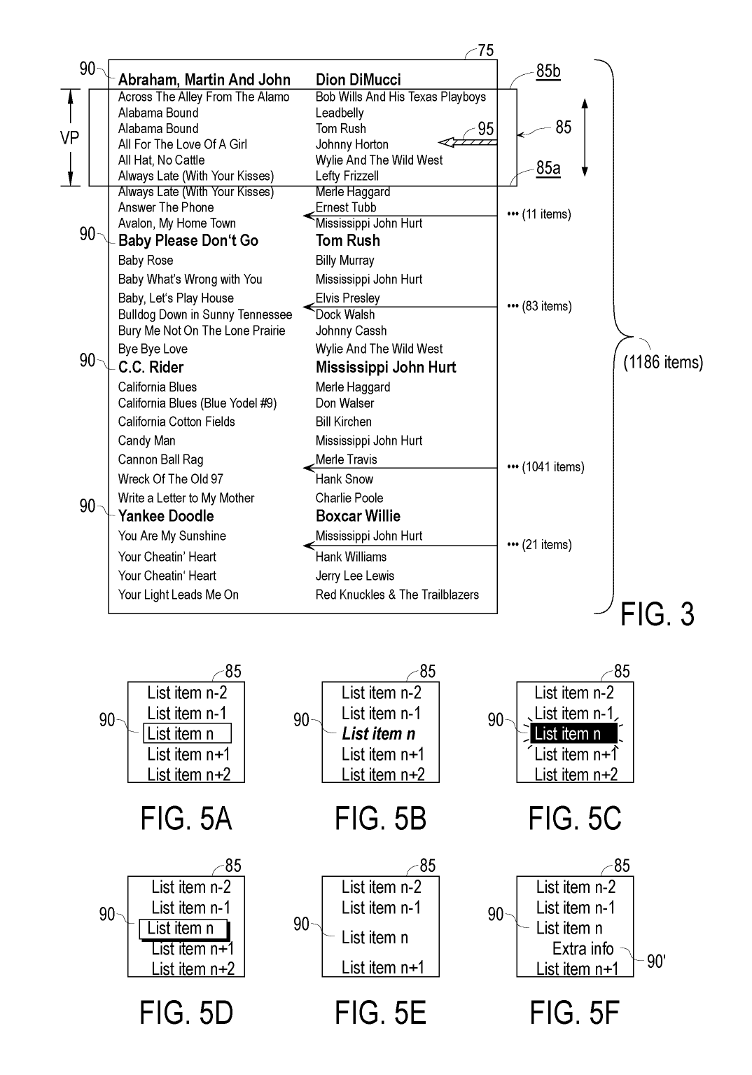

FIG. 3 is a schematic view showing an example of list 75 to be scrolled and a viewport 85 within which a small portion of the list can be displayed at any given moment. A double-headed arrow represents the fact that the viewport and the list can be scrolled relative to each other (parallel to a vertical scroll axis in the orientation of the figure). In this particular example, the list items represent music tracks, and the list includes a number of frictional items 90, which are shown with their text bolded and enlarged. In some cases, the viewport is commensurate in size with display 20, but in other cases the viewport can occupy only a portion of the display. A cursor 95 is shown displayed within viewport 85.

Viewport 85 has edges 85a and 85b extending transversely (horizontally in the orientation of the figure) with respect to the scroll axis. If the viewport is moving downwardly relative to the list (“scrolling down”), edge 85a is the leading edge and edge 85b is the trailing edge. Conversely, if the viewport is moving upwardly relative to the list (“scrolling up”), edge 85b is the leading edge and edge 85a is the trailing edge. As mentioned above, the leading edge of the viewport and the cursor can be useful reference positions for describing the scrolling.

Cursor 95 is shown as a hatched arrow pointing at a selected list item in the viewport. As mentioned above, some embodiments entail scrolling a cursor position relative to the list, and a rendered arrow is but one way of displaying a cursor position. Other possibilities include drawing a contrasting box around the selected item or highlighting the selected item. The cursor is shown as being about halfway between edges 85a and 85b of the viewport, but some implementations can have the cursor assuming a position adjacent the leading edge of the viewport when the cursor reaches the last displayed item in the viewport.

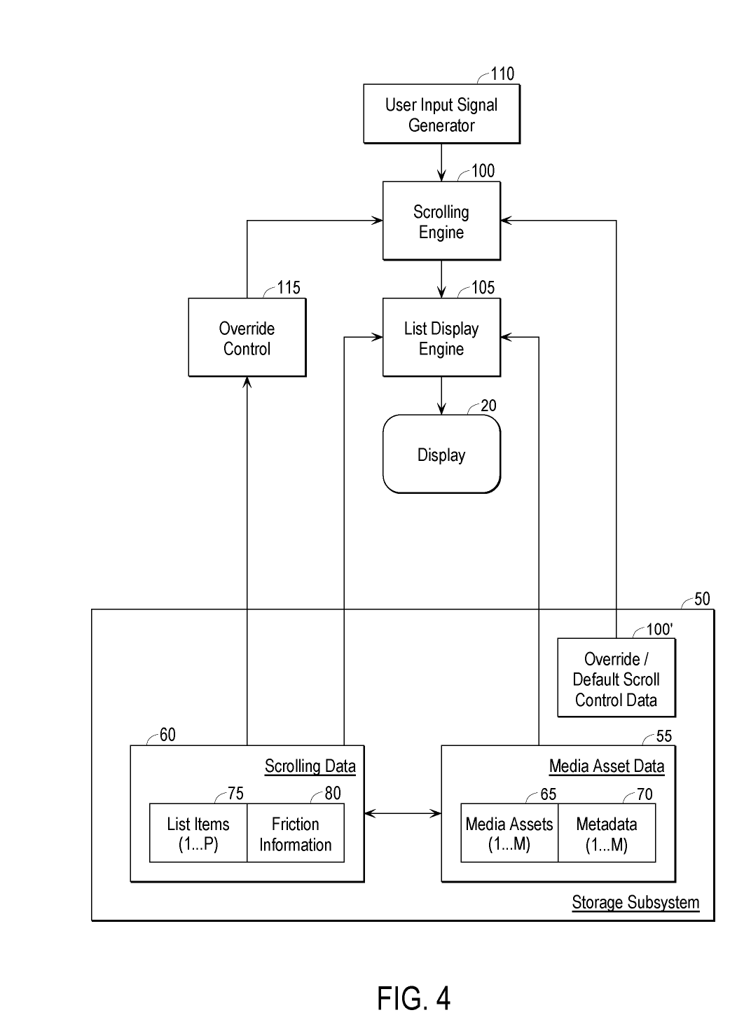

FIG. 4 is a block diagram of elements that provide scrolling control according to an embodiment of the present invention. Elements that are directly responsible for displaying scrolled lists on display 20 include a scrolling engine 100 having associated scroll control data 100′ and a list display engine 105. A user's manipulation of an interface element is converted by a user input signal generator 110 into an electrical signal based on the user's actions, which electrical signal represents a scrolling request.

Scrolling engine 100 receives signals representing scrolling requests from user input signal generator 110, converts or maps these signals to a scroll control signal that is communicated to list display engine 105. Scrolling engine 100, with its scroll control data 100′, supports default mapping and override mapping as determined by an override control 115. In some embodiments, the override mapping feature can be enabled and disabled as a matter of user preference. Friction information 80, scrolling engine 100, scroll control data 100′, list display engine 105, and override control 115 represent one way of implementing the functionality of scroll control mechanism 5 and friction-imparting mechanism 8 shown in FIGS. 1A-1E.

Scroll control data 100′ can include, for example, parameter values, lookup tables, and the like to support the default mapping and one or more override mappings, as will be described in greater detail below. Override control 115 determines which mapping is to be applied to the signal from user input signal generator 110 depending on whether one of frictional items 90 satisfies a proximity constraint with respect to the reference position.

A proximity constraint is a condition relating to the relative position of a frictional item and the reference position. For example, the proximity constraint can be a requirement that a frictional item be within a range of item positions relative to the reference position. The range can surround the reference position, abut the reference position, or be spaced from the reference position. The particular ranges can vary with the speed of scrolling, and the proximity constraint can differ for different kinds of frictional items.

Thus, depending on which mapping is in effect, the device can be considered to be in a selected one of first and second scroll control states (referred to as default and override states). Each scroll control state can be considered to be characterized by a different mapping of scrolling requests. Additional embodiments of the present invention can include more than two scroll control states. Further, the transition from one state to another need not be abrupt; rather override control 115 can be configured to provide a gradual transition from the override mapping to the default mapping. However, this transition can also be viewed as a characteristic of a single override mapping.

List display engine 105 is responsible for determining which list items to draw on the display, how to represent the list items, how to scroll the list items in response to the scroll control signal from scrolling engine 100, and how to represent frictional items 90. Techniques for differentiating frictional items from other items will be discussed in detail below. The list display engine is shown as receiving information from media asset data structure 55 (which includes media assets 65 and metadata 70) and scrolling data structure 60 (which includes list items 75 and friction information 80). Depending on how the list items are to be drawn, metadata may provide sufficient information from media asset data structure 55.

Lists to be scrolled are generated dynamically on the basis of user interactions, e.g., menu selections and the like, and can also arise when a given item in a list is selected. For example, where media assets can be accessed via a hierarchical menu structure, selecting a particular item at the most atomic level can entail scrolling through different lists at higher levels.

As a concrete example, consider where a high-level menu presents a list of options for selecting songs, say by playlist, artist, album, compilation, genre, song, or composer. Selecting one of these options (except for song) provides a list of higher-level constructs, and the user can scroll through these, select one, and either commence playing the songs in that category or access a list of all the elements in that category.

Embodiments of the present invention are not limited to any particular way in which the user invokes scrolling through the list. On a PMD such as some versions of the iPod®, the user may invoke scrolling by touching scroll wheel 25 and moving a finger in a circular motion. At different times, the scroll wheel has been implemented as an actual rotatable member, or as a series of fixed capacitive sensors disposed under a fixed annular region of the PMD body, which the user “moves” by touching and moving a finger in a circular motion. PMDs and computers with touch interfaces allow various gestures to cause scrolling. It may also be possible to invoke scrolling by holding one of buttons 30 down (e.g., the Forward or Backward button), with the duration during which the button is pressed determining the final default scrolling speed.

Pointing devices for computers may have rotatable scroll wheels or scroll rings. PMDs and computers with touch interfaces may allow various gestures to cause scrolling. Other possible ways for a user to scroll through a list is to interact with a displayed user interface control element (e.g., scroll bars or scroll buttons) using a pointing device, a stylus, a finger, or any other desired mechanism. Further, in some programs, arrow keys (Up, Down, Right, and Left) can be used to move the cursor position until reaching the end of the viewport, at which point the viewport begins scrolling.

A particular type of scrolling, known as “flick” scrolling, is effected by the user making a flicking gesture to initiate scrolling, which continues until the user stops the scrolling or the end of the list is reached. This can be implemented in touch-based systems (e.g., trackpad or touchscreen), in scroll-wheel-based systems (mechanical wheel or capacitive sensors), or in systems with conventional pointing devices. The speed of the scrolling can depend on the speed of the flick. Flick scrolling has the potential of providing very fast scrolling, but the user needs to be careful to stop the scrolling near the desired item on the list. The user can then navigate to the desired item using a finer, but slower, technique.

In all these techniques for requesting scrolling, the user actions are converted into signals, typically electrical signals, that that are then mapped to signals that will control the scrolling. Scrolling engine 100, list display engine 105, user input signal generator 110, and override control 115 can be separate hardware components, software components, or a combination. To the extent that some of these are implemented in software, the code that is executed can be stored in storage subsystem 50. For convenience, the signal provided by user input signal generator 110 can be thought of as a motion signal, even though some of the user actions (e.g., button presses, voice commands) do not entail movement of an actuator or a finger where the distance of the movement has significance.

Scrolling engine 100, list display engine 105, user input signal generator 110, and override control 115 are drawn as separate elements, the final output of which provides a scrolling list on display 20. This is for convenience only. Depending on the implementation, some of these elements could be more tightly integrated into the list display engine.

As a matter of nomenclature, list items that are moving toward the viewport are considered to be at positions leading up to the viewport (or before the viewport), while items that have left the viewport are considered to be at positions past the viewport. In some embodiments of the present invention, the scrolling is stepped in the sense that list items enter the viewport in their entirety. That is, there is no condition where an item is only partially in the viewport. Other embodiments of the present invention can allow partial list items to appear in the viewport. To the extent that items enter the viewport in their entirety, the item that has just entered the viewport can be considered to be at the leading edge of the viewport. The nomenclature for references to the cursor position are generally consistent with the nomenclature for the viewport. Thus, items moving toward the cursor are considered to be at positions leading up to the cursor and items that are moving away from the cursor are considered to be at positions past the cursor.

The normal meaning of scrolling the list is causing the list items (text or graphics) to move up, down, or across the viewport, or in such directions relative to the cursor. For slow scrolling, each sequential item will typically be displayed; for faster scrolling, each item might be displayed, but possibly so quickly that the user cannot discern the individual items. For extremely fast scrolling, it may be impossible to draw each item on the display, and a representation of scrolling may be presented (e.g., as a visual blur). For rapid scrolling of items such as image thumbnails, drawing of the items on the display may cease, with the cursor being the only element actually drawn on the display.

In the context of the present application, a statement that an item or items appear and move relative to the display should be taken to include the possibility that the items are not actually being drawn if the scrolling speed is sufficiently high. Further, reference to movement relative to the display should not be taken as limited to any particular direction; thus the items in the list might be moving up, down, to the left, or to the right. For example, scrolling through hierarchical menus may include vertical and/or horizontal movement. Also, scrolling through a two-dimensional array of list items such as thumbnails of images is sometimes implemented by highlighting sequential items in a row, and then bringing another row onto the display after reaching the last item in the row at the bottom or top of the display.

Further, depending on the context and the manner in which scrolling is invoked, the currently selected item (if any) may or may not be correlated with the scrolling. In some contexts, an item within the viewport is selected, and then a user interface element is manipulated to select another item within the same viewport (i.e., the scrolling changes the cursor position only). In other contexts, an item within the viewport is selected, and then a user interface element is manipulated to change the viewport without changing which item is selected (i.e., the scrolling changes the viewport only).

In yet other contexts, an item within the viewport is selected, and then a user interface element is manipulated to change which item is being selected, and after the cursor position reaches an edge of the viewport, successive selected items enter the viewport (i.e., the scrolling changes the cursor position and the viewport). Within this context, the next selected item in the viewport is not necessarily the next item in the list. For example, in some implementations, when thumbnails are being scrolled, the cursor position moves across each row until reaching the last thumbnail in the last row in the viewport (e.g., at the bottom right corner for scrolling down, the upper left corner for scrolling up), and then the cursor remains at the that position as a new row enters the viewport (i.e., the cursor position is then jumps a row at a time, selecting only the last thumbnail in each successive row).

In the particular example shown in FIG. 3, the list items are text representing selected metadata fields (track name or title, and artist name) for a music collection. The list is shown schematically as having 1186 items with viewport 85 being sized to display six items. As mentioned above, the list items could be text representing higher levels in the music hierarchy. Even for a relatively small music collection such as illustrated, the number of albums might be in the range of 50-100, which represents a sufficiently long list to benefit from embodiments of the present invention.

The schematic of the list does not necessarily reflect exactly what would be displayed. For example, in some implementations each list item can be displayed as two lines, with the track title larger than the artist name. Similarly, frictional items 90 are not required to be visually differentiated from the other items, although that is an optional feature to be discussed below. Additionally, the list items do not have to be limited to textual items; for example, the items in list 75 could be thumbnails of pictures, with or without accompanying textual information. In such a case, the thumbnails can be arranged with multiple items on each row, and scrolling can be in raster fashion or in boustrophedonic fashion.

In this example, the list items are sorted alphabetically by track name, followed by artist name, but any desired or convenient sort order can be used. Similarly, this is but one example of a list of items to be scrolled; others include but are not limited to a list of contact names in a contacts database, a list of tasks in a project management application, a list of appointments in a calendar, a list of applications or other files in a file browser.

For illustrative purposes, frictional items 90 have the characteristic that each is the first item in the list starting with a new letter of the alphabet. In the specific illustrated example, the frictional item “Baby Please Don't Go” is the first item starting with the letter “B” and is therefore designated as frictional. Similarly, the frictional item “Yankee Doodle” is designated as frictional since it is the first item starting with the letter “Y.” It is not necessary to make frictional items for every letter of the alphabet. For example, if there were only two items starting with a “B,” it might suffice to make the first item beginning with “B” frictional, but not make the first item beginning with a “C” frictional.

In this simple example, the items are frictional by virtue of their presence in the list and the absence of any other items starting with the same letter but being alphabetically earlier. For example, if “Yankee Doodle” were removed from the list, “You Are My Sunshine” would be frictional. This does not mean to say that “You Are My Sunshine” couldn't also be frictional. For example, if one of the criteria for a track being frictional is that the track is one of the most frequently played tracks, and if “You Are My Sunshine” met that criterion, it would be frictional regardless of its position in the list.

In general, the friction property is most useful when it is applied to items that are likely to be more relevant to the user than other items. For example, in the case of media tracks, the user may want his or her favorite tracks to be frictional. This can be accomplished manually by the user designating the track as frictional, or automatically by the system designating tracks as frictional if they have been otherwise rated highly by the user (e.g., for playlist selection) or if they have among the highest frequencies of play. Similarly, the most recently purchased tracks can be designated as frictional.

For a contact list, the most frequently called and/or the most recently called contacts can be designated frictional since there is a reasonable probability that these contacts are more relevant to the user than the other hundreds or thousands of contacts in the list. For a to-do list sorted by due date, the highest priority items can be designated frictional to provide the user an additional way to view the list.

As mentioned above, frictional items 90 in list 75 are shown as bolded and enlarged to make them stand out in the figure. However, as also mentioned above, embodiments of the present invention can also render the frictional items so that they are visually differentiated from the remaining items when they are displayed. For example, this can be done by doing one or more of the following: putting a border around the item, changing one or more text style attributes of the item, applying one or more animation features to the item, providing a 3-D aspect to the item, leaving additional space between the item and its neighbors, and displaying additional information with the item (or an alternative representation instead of the default representation).

FIGS. 5A-5F show schematically the six different ways mentioned above that can be used to visually differentiate frictional items 90 from their neighbors. Each of FIGS. 5A-5D shows five textual list items within viewport 85; the techniques shown in FIGS. 5E and 5F expand the space taken up by the frictional item, as a result of which only four list items fit in the viewport. These techniques are in general not mutually exclusive, and so multiple techniques can be combined.

FIG. 5A shows the case where frictional item 90 is differentiated from its neighbors by putting a border around the frictional item. The border is shown as a solid border, but dotted and dashed lines can also be used. However, if the environment is such that scrolling is accompanied by drawing a border around sequentially selected list items (e.g., for thumbnail images), a different color, weight, or style of border can be drawn, and the borders around the frictional items would contrast with other borders that might be drawn around items in the normal course of scrolling.

FIG. 5B shows the case where the frictional item 90 is differentiated from its neighbors by changing one or more text style attributes. Text style attributes can include, but are not limited to, one or more of font, size (one or both dimensions), italic, bold, single or multiple underline, color, outline, shadow, emboss, engrave, or case (e.g., all caps or small caps). Since changing the given item's appearance is typically done to emphasize the given item, less likely text style attributes to be applied might include single or multiple strikethrough, superscript, or subscript. For the particular example shown in FIG. 5B, the frictional item is drawn in bold italic type.

FIG. 5C shows the case where frictional item 90 is differentiated from its neighbors by applying one or more animation features. Animation features can include, but are not limited to, one or more of blinking background, Las Vegas lights, marching black ants, marching red ants, shimmer, or sparkle text. For the particular example shown in FIG. 5C, the frictional item is drawn as having a blinking background with alternating text color for contrast. Since this is a static drawing, only the contrasting portion of the animation is shown.

It is noted that this figure, were there not blinking, can represent a different text style (i.e., different type and background colors). This figure, without the representation of blinking, can also represent highlighting the frictional item. However, if the environment is such that scrolling is accompanied by sequential highlighting of the list items, the highlighting of frictional items can use a different style of highlighting (e.g., a different background color), and the highlighting applied to the frictional items would contrast with the highlighting applied to items in the normal course of scrolling.

FIG. 5D shows the case where frictional item 90 is differentiated from its neighbors by providing a 3-D aspect to the item. Possible 3-D aspects can include, but are not limited to, one or more of lift-off, or drop shadow. For the particular example shown in FIG. 5D, the frictional item is drawn as lifted off the plane of the drawing and provided with a drop shadow.

FIG. 5E shows the case where frictional item 90 is differentiated from its neighbors by leaving additional space between the item and its neighbors.

FIG. 5F shows the case where frictional item is differentiated from its neighbors by displaying additional information 90′ regarding the given item, either instead of or in addition to, information that is displayed for other items on the list. The additional information can be textual, graphic, or both. For the particular example shown in FIG. 5F, the additional information is textual.

As mentioned above, scrolling through a list can entail moving a viewport relative to the list or moving a cursor position relative to the list, or both. When the list is moving relative to the viewport, the leading edge of the viewport is a convenient reference position, and the list item that has just entered the viewport can be considered to be at the reference position. To the extent that a cursor position is displayed, the selected list item, or the list item adjacent the cursor position (where no items are selected) can be considered to be at the reference position.

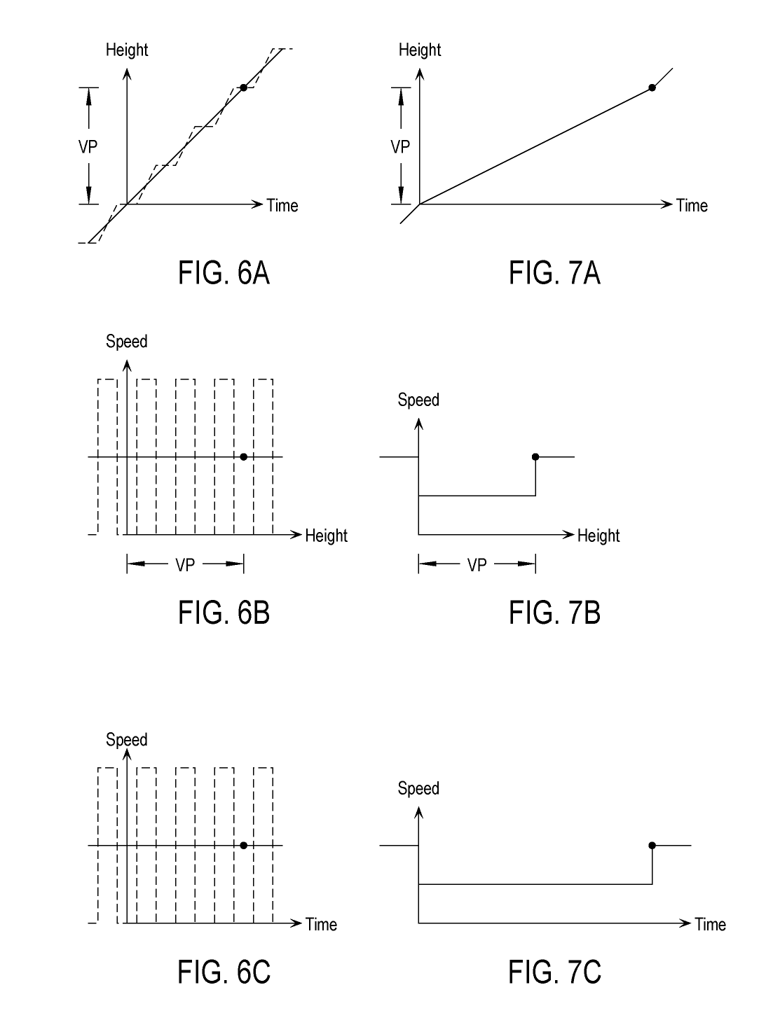

There are a number of possible ways that the normal (default) scrolling can be overridden (modified) to allow the user an extra opportunity to select a frictional list item. A default mapping (FIGS. 6A, 6B, and 6C), and override mappings for each of several embodiments of the present invention (FIGS. 7A through 11C) will be described below in terms of scrolling relative to a viewport. However, as will be explained, the same considerations can apply to scrolling relative to a cursor position with a fixed viewport. The default mapping and the override mappings of each of the embodiments of the present invention will be demonstrated using the following three plots:
(a) height of the frictional item in the viewport as a function of time;
(b) scrolling speed of the frictional item as a function of height in the viewport; and scrolling speed of the frictional item as a function of time.

In the plots as a function of time, the origin (t=0) is the point at which the frictional item enters the viewport. The “height” in the viewport refers to the distance the list item has traveled in the viewport since entering. An item's height is assumed to increase after entering the viewport regardless of the direction of scrolling. For embodiments where there is a provision to snap back after overshooting (i.e., where the item has left the viewport), the same convention can apply; the list is just being scrolled in the opposite direction, but height increases in the direction of travel. A negative height refers to the position of the frictional item before it enters the viewport. Speed is positive or zero.

Scrolling at a given speed is intended to cover situations where the relative movement pauses after each item enters the viewport, with the speed shown in the graphs representing an average speed. Thus a reduced speed can correspond to increased durations during which the items are paused. In some embodiments of the present invention, scrolling can appear to be smooth at the default speed but visibly stepped during the slower scrolling.

The mappings introduced above and discussed below, with minor changes in terminology, can be used to characterize the way a cursor is moved relative to the items. The counterpart to the viewport can be a given distance (number of list items) surrounding the cursor. Thus the notion of a frictional item entering the viewport has the counterpart of the cursor coming within the given distance of the frictional item. Once the cursor reaches the end of the physical viewport, the cursor position and the leading edge of the viewport are coincident.

FIGS. 6A, 6B, and 6C are the three plots of (height vs. time, scrolling speed vs. height, and scrolling speed vs. time) for a default mapping. A large black dot is drawn to show the time or position where the frictional item leaves the viewport. For simplicity, the speed is taken as a constant, so the height increases linearly with time. This is not intended to negate a situation where the user causes the scrolling to have a non-uniform speed. Any other profile could be imposed on the linear profile.

Also shown superimposed on the plots are dashed waveforms showing how the scrolling can be implemented as intermittent movement. In this example, the average speed is realized by alternating periods of movement at twice the average speed and periods of zero speed. Other duty cycles for the moving and paused intervals can also be used. Similar waveforms can be applied to the graphs for the embodiments discussed below, but are omitted for clarity.

FIGS. 7A, 7B, and 7C are the corresponding three plots for an embodiment of the present invention where the scrolling speed is reduced during the entire time that the frictional item is in the viewport. Thus, the slope shown in FIG. 7A and the velocity level shown in FIGS. 7B and 7C have an initial default value as the frictional item approaches the viewport, a reduced value (½ in this example) during the time the frictional item is in the viewport, and the default value when the frictional item has left the viewport. A value of ½ is exemplary. For example, an extremely fast default scrolling can militate to a larger relative speed reduction (say ¼ or 1/10). In this embodiment of the present invention, the proximity constraint for invoking override scrolling is that the frictional item be in a range commensurate with the viewport.

In a situation where the list is not moving relative to the viewport, but rather a cursor is moving from item to item in the viewport, the cursor position can be can be represented by a position halfway up the interval denoting the height of the viewport, and the “height” of the viewport can be taken to represent a plurality of list items in the neighborhood of the frictional item. Thus, the cursor would slow down when it was within a particular number of items of the frictional item, and then speed up after it is no longer with a particular number of items of the frictional item.

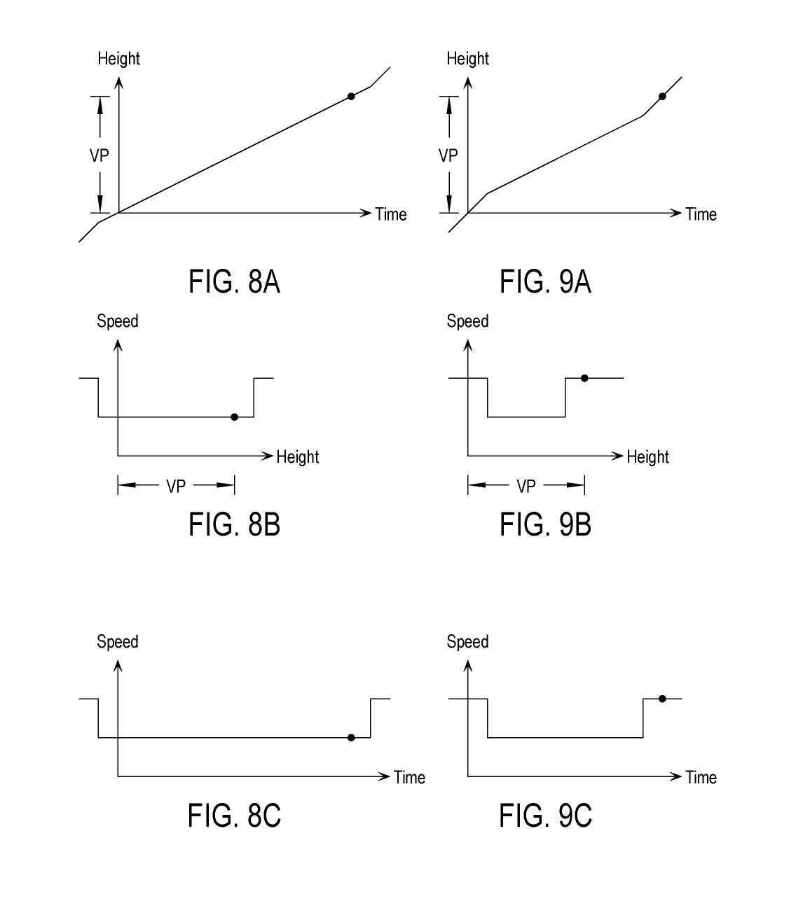

FIGS. 8A, 8B, and 8C are the corresponding three plots for an embodiment of the present invention where the scrolling speed is reduced during an interval before the frictional item enters the viewport, during the entire time that the frictional item is in the viewport, and during an interval after the frictional item leaves the viewport. Again, for the example, the speed is reduced by a factor of 2 while the frictional item is passing through the viewport, and for short intervals as the frictional item is approaching the viewport and just after it has left the viewport. The intervals during which the frictional item is outside the viewport at the reduced speed before entering and after leaving the viewport are shown as equal, but this is not necessary. In this embodiment of the present invention, the proximity constraint for invoking override scrolling is that the frictional item be in a range that is longer than the viewport and begins before the leading edge of the viewport.

FIGS. 9A, 9B, and 9C are the corresponding three plots for an embodiment of the present invention where the scrolling speed is reduced during a portion of the time that the frictional item is in the viewport. In this embodiment of the present invention, the proximity constraint for invoking override scrolling is that the frictional item be in a range that is shorter than the viewport the viewport and begins after the leading edge of the viewport.

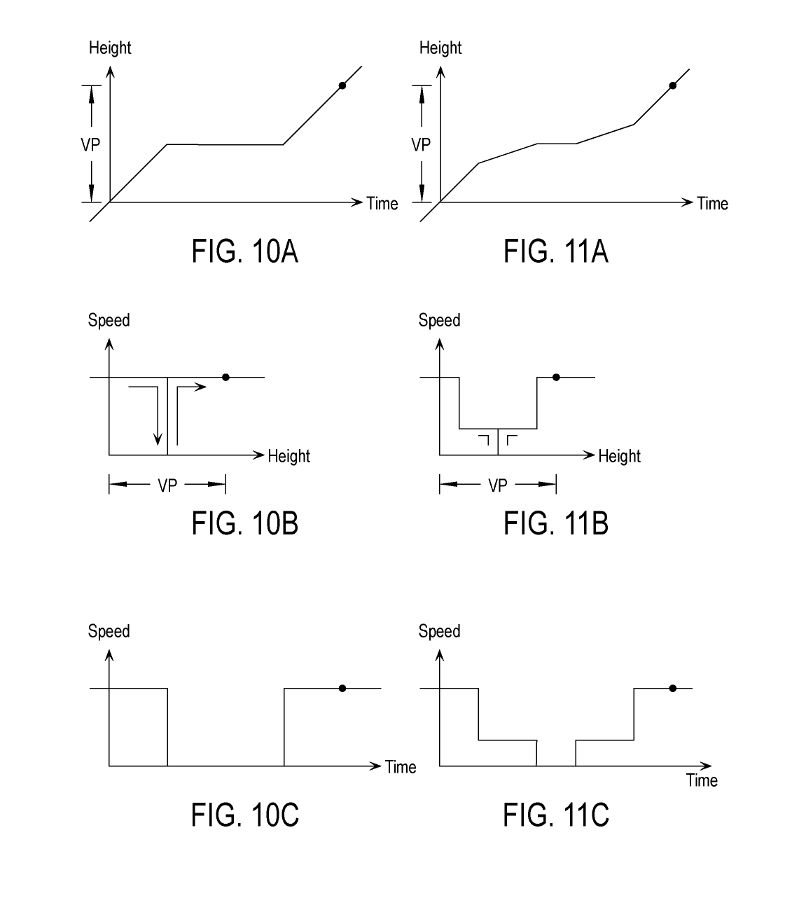

FIGS. 10A, 10B, and 10C are the corresponding three plots for an embodiment of the present invention where the scrolling speed is reduced to zero (i.e., scrolling pauses) during a portion of the time that the frictional item is in the viewport. In this example, scrolling proceeds at the default speed until the frictional item reaches halfway through the viewport, at which point the frictional item pauses, and then scrolling resumes at the default speed. In this embodiment of the present invention, the proximity constraint for invoking override scrolling is that the frictional item be in a range that limited to a single position that is spaced from the leading edge of the viewport by a distance on the order of half the viewport dimension.

In the plot of speed as a function of height (FIG. 10B), it is impossible to determine the length of time the frictional item is paused. However, for this example, the frictional item pauses for a time that is equal to the total time that it was moving through the viewport. This can be seen in the plots of height as a function of time (FIG. 10A) and speed as a function of time (FIG. 10C). For very fast speeds, the frictional item can be paused for a proportionately longer time.

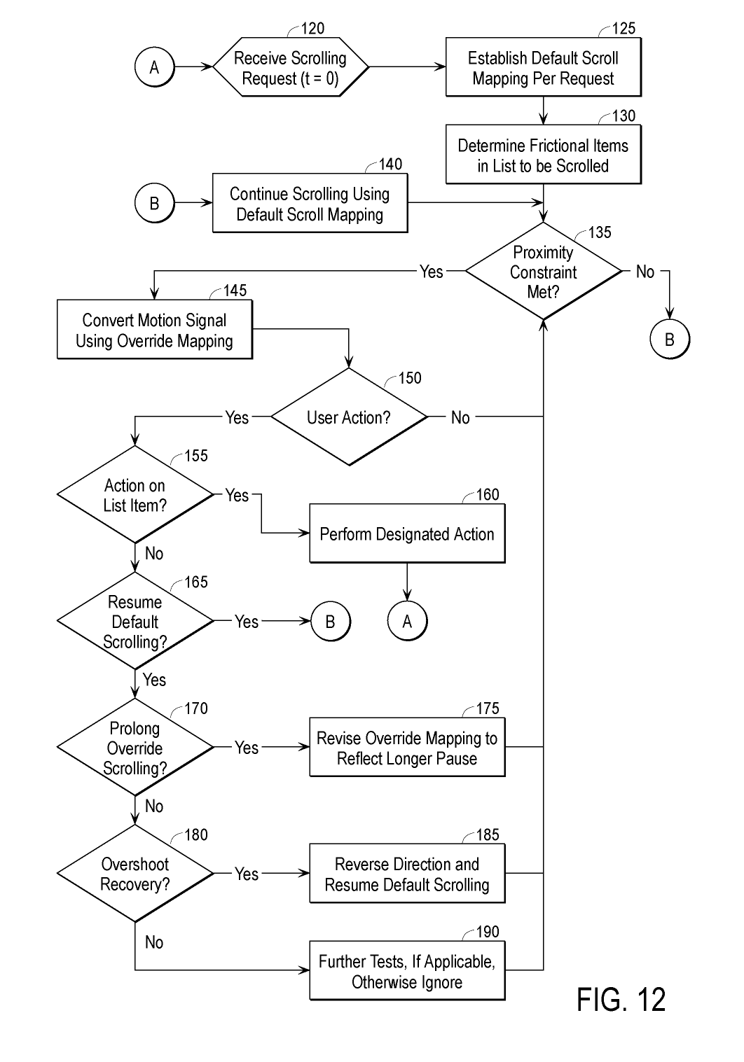

FIGS. 11A, 11B, and 11C are the corresponding three plots for another embodiment of the present invention where the scrolling speed is reduced to an intermediate value (⅓ in the example), and then to zero (i.e., scrolling pauses) during a portion of the time that the frictional item is in the viewport. The speed is shown as then increasing in a symmetric fashion, but this is not necessary. As in the embodiment of the present invention described above in connection with FIGS. 9A, 9B, and 9C, the proximity constraint for invoking override scrolling is that the frictional item be in a range that is shorter than the viewport and begins after the leading edge of the viewport.

The invention is not limited to any particular values of the scroll override parameters (e.g., speed reduction, duration of reduced speed, or time for which scrolling might be paused when the frictional item is in the viewport or near the cursor). As mentioned above, different values can be used for different default scrolling conditions. Additionally, speed reductions and times of slow scrolling or paused scrolling can be tailored to user expectations and reflexes, and some embodiments of the present invention can give the user the opportunity to set typical time scales. For impatient users with fast reflexes, a second or less may be sufficient. Other users may prefer longer times, say 2-4 seconds. As mentioned above, in some embodiments of the present invention, the user can specify override parameters as part of configuring the device.

As mentioned above, the various ways that the default mapping can be overridden can be modified or limited in view of other considerations. For example, in some embodiments of the present invention, the default scrolling speed can be taken into account. For example, if the default scrolling is currently slow, the effect of the override can be reduced. This can manifest itself in a slowdown factor or a pause duration that increases as scrolling speed increases. This was alluded to above. Additionally, embodiments of the present invention can disable the override entirely for scrolling speeds below a specified threshold. These possible modifications to the override can themselves be implemented as user-settable preferences.

Similarly, the override can take the list length can into account. For example, the override characteristics can be reduced for shorter lists, and even disabled for lists containing fewer than a specified number of items. This could be implemented in connection with providing different override behavior for different types of frictional items. For short lists, some automatically designated frictional items (e.g., the first item beginning with a given letter) could be disregarded while items designated by the user as frictional could retain the normal override treatment.

Embodiments of the present invention provide a number of ways that the user can interact with frictional items. Some of these ways will depend on the manner in which the default mapping is overridden for frictional items. In the examples that follow, reference will be made to a user activating a user interface element. Such statements should be interpreted to include the user performing a particular gesture for embodiments having touch interfaces or speaking a voice command for embodiments having voice control interfaces.

In one embodiment of the present invention, activation of a particular user interface element (e.g., the Play/Pause button) when a frictional item is moving at reduced speed through the viewport can be interpreted to cause scrolling to pause. This can give the user the opportunity to select the frictional item and invoke an action on it (e.g., play the item, explore further information about the item). In some variations, the frictional item can be automatically selected, regardless of its position in the viewport; in other variations, the item at a particular position in the viewport (not necessarily the frictional item) can be automatically selected. A second activation of the user interface element, or activation of a different user interface element, for example without the user performing any selection or scrolling, can be interpreted to cause scrolling to resume at the default speed.

In another embodiment of the present invention, activation of a particular user interface element (the same or a different one as in the above embodiment) when a frictional item is paused in the viewport can be interpreted to cause scrolling to pause for an increased amount of time relative to the pause duration in the absence of such activation. A second activation of the user interface element, or activation of a different user interface element, for example without the user performing any selection or scrolling, can be interpreted to cause scrolling to stop entirely.

In another embodiment of the present invention, activation of a particular user interface element after a frictional item has passed through the viewport can be interpreted to cause scrolling to reverse to bring the frictional item back into the viewport. This can be considered as an indication that the override scrolling still overshot the desire to select a frictional item. This can be qualified by the distance that the frictional item has gone past the viewport. As an adjunct or alternative to this, in another embodiment of the present invention, activation of a particular user interface element while a frictional item is in the viewport can be interpreted to cause the next frictional item in the list to be brought into the viewport.

As mentioned above, items can be designated as frictional automatically or can be designated by the user, and the criteria for automatically designating frictional items can be controlled by the user as a stored preference. Further, as mentioned above, the degree of friction need not be binary. Thus, embodiments of the present invention allow different responses to different degrees of friction.

For an example with two non-null levels of friction, for embodiments where frictional items are slowed down near the reference position, the frictional items with the greater amount of friction can be slowed down more than the frictional items with the lesser amount of friction. Similarly, for embodiments where frictional items pause near the reference position, the frictional items with the greater amount of friction can pause for a longer than the frictional items with the lesser amount of friction.

These examples are but instances of having different override mappings for different frictional items. Other combinations are possible, for example some embodiments can slow some frictional items and pause others, or use different combinations of slowing and pausing, as well as performing the operations at different distances from the reference position. As mentioned above, in some embodiments, the override mapping takes into account the actual speed of the scrolling.

FIG. 12 is a flowchart showing operation in accordance with an embodiment of the present invention. The flowchart shows a node (“Node A”) at the top left that is drawn as an “A” in a circle. This is a default state where no scrolling is occurring, and operations unrelated to scrolling may be occurring. The flowchart also shows a node (“Node B”) that is drawn as a “B” in a circle. This is a return point after scrolling with the override mapping (“override scrolling”) ends and scrolling with the default mapping (“default scrolling”) resumes.

Before a user action is interpreted as a scrolling request, there needs to be a list to scroll (for example, if the current display state of a PMD is showing particulars of the song being played, an interaction with the scroll wheel may be interpreted as a volume change request rather than a scrolling request). A list can be assembled in response to user actions, such as selecting a menu item such as “Playlists” or “Albums” from a list of music selection items (note that arriving at the item to be selected can be the result of a previous scrolling request).

The processing starts with the receipt or detection of a scrolling request at a node 120. In response to the scrolling request, a default scroll mapping is established at a step 125 in accordance with the nature of the user signals and the nature of the list to be scrolled. As mentioned above, different user actions are interpreted to be requesting different scrolling parameters (e.g., direction, speed, acceleration).

Once it is determined what the nature of the list is, the list items are identified, and at a step 130, the frictional items in the list to be scrolled are determined. It is not necessary that friction information for the entire list be assembled; rather, in some embodiments of the present invention, friction information for a beginning portion of the list is assembled, and friction information for later portions of the list can be deferred until it appears that scrolling will continue through the later portions. In any event, it will be assumed in the following discussion that the necessary override parameters (including proximity constraints as well as speed profiles) will be available.

At a test block 135, it is determined whether the next frictional item in the list meets the appropriate proximity constraint with respect to the reference position. As mentioned above, different frictional items can have associated different proximity constraints. If the next frictional item in the list does not meet the appropriate proximity constraint, control transfers to Node B and default scrolling continues at a step 140, and control passes again to test block 135. This is, in effect a loop that continuously tests to determine the first time that the proximity constraint is met, and hence the onset of override scrolling.

If it is determined at control block 135 that the next frictional item in the list does meet the relevant proximity constraint, override scrolling commences (or continues if it was already occurring) at a step 145, where the motion signal is now converted using the override mapping. In general, override scrolling will cease under at least one of two circumstances. The first is where the override scrolling has progressed to where the proximity constraint is no longer met (e.g., the slowed-down frictional item has left the viewport). Put another way, the override scrolling has served its purpose of giving the user an extra chance to take an action on the frictional item. The second is where certain user actions occur. Excluded would be the user actions where the user continues doing whatever the user was doing that gave rise to the scrolling request in the first place.

At a test block 150, it is determined whether a user action has occurred. If no user action has occurred, control passes again to test block 135. This is, in effect a separate loop that continuously tests to determine the first time that the proximity constraint has ceased to be met. If it is determined that a user action has occurred, a number of tests are performed to determine the type of action and the requisite response. A representative series of tests will now be described.

At a test block 155, it is determined whether the user action is an action on a list item (while the override scrolling was for the purpose of giving the user an extra opportunity to select the frictional item, the action can also be on another nearby item). If it is determined that the user action is for the purpose of taking an action on a list item, the appropriate action is taken on the list item at a step 160, and control passes to Node A. At this point scrolling is no longer occurring, and the system waits for further events such as a scrolling request.

If it is determined at test block 155 that the user action is not an action on a list item, then at a test block 165, it is determined whether the user action is a request to resume default scrolling. If the user action is a request to resume default scrolling, control passes to Node B, with the result that default scrolling continues at step 140.

If it is determined at test block 165 that the user action is not a request to resume default scrolling, then at a test block 170, it is determined whether the user action is a request to prolong override scrolling. Some possible ways to do so were discussed above, including slowing down further, or pausing rather than slowing, or pausing longer. An additional way is to relax the proximity constraint so that it remains in effect longer. If the user action is a request to prolong override scrolling, the override mapping is modified at a step 175, and control passes to test block 135 to monitor the proximity constraint.

If it is determined at test block 170 that the user action is not a request to prolong override scrolling, then at a test block 180, it is determined whether the user action is a request to reverse the direction of scrolling due to an overshoot. If the user action is a request to reverse scrolling, then at a step 185, scrolling is reversed and using the default scrolling profile. Control then passes to test block 135 to monitor the proximity constraint.

If it is determined at test block that the user action is not a request to reverse the direction of scrolling, then further tests can be performed if there are other user actions possible during scrolling. This is shown schematically in the flowchart as a step 190 to perform further tests, if applicable, or otherwise to ignore the user action and return to test block 135.

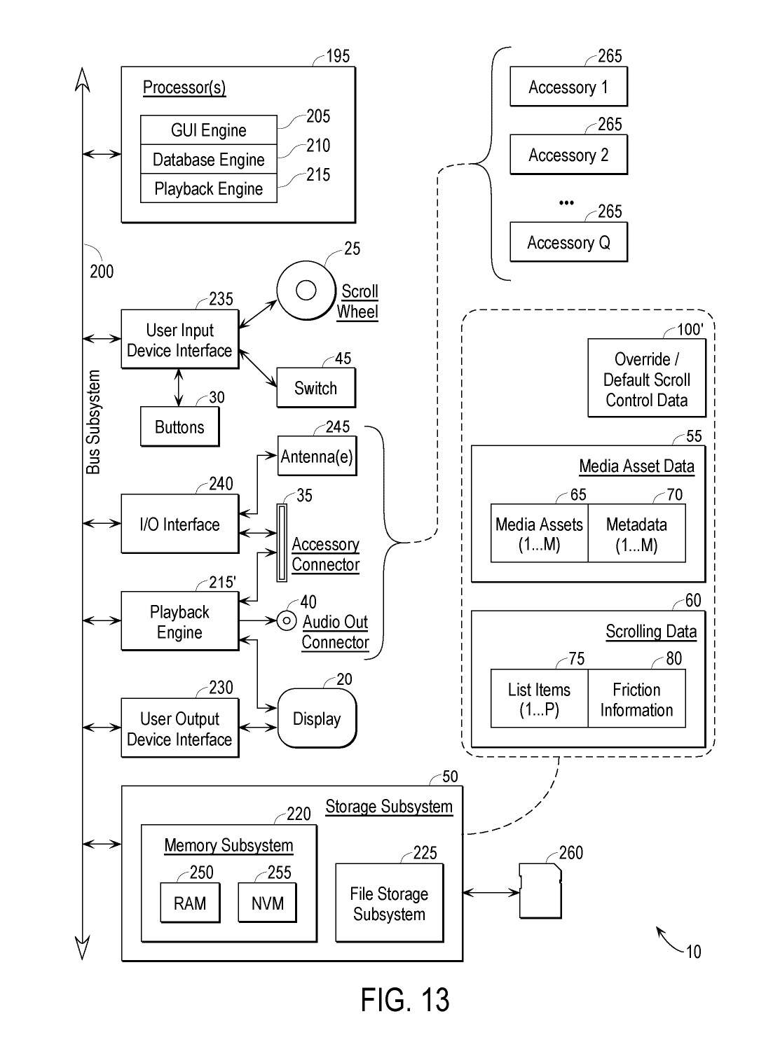

FIG. 13 is a block diagram of a device according to an embodiment of the present invention. For concreteness, the example of PMD 10 will be used, it being understood that PMDs and other devices according to embodiments of the present invention do not need to contain all the components shown, and further that they may contain additional components. Again for concreteness, the description of PMD 10 will be in terms of a device that, among other things, plays music.

PMD 10 is preferably processor-based, and to that end typically includes at least one processor 195, which can be a conventional microprocessor or microcontroller. The processor can communicate with a number of peripheral devices via a bus subsystem 200. The processor is shown as implementing a graphical user interface (“GUI”) engine 205, a database engine 210, and a playback engine 215. Bus subsystem 200 provides a mechanism for letting the various components and subsystems of PMD 10 communicate with each other as intended. Although bus subsystem 200 is shown schematically as a single bus, embodiments of the bus subsystem may utilize multiple buses, and various of the components may have private connections. Although the specifically described embodiments are processor-based embodiments, other embodiments can be implemented with other types of controllers such as combinatorial logic.

In addition to storage subsystem 50, which is shown as having a memory subsystem 220 and a file storage subsystem 225, the devices on the bus can include various interface controllers for interfacing to other devices or functional elements that do not interface to other devices. In the representative configuration shown in FIG. 3, the additional devices include a user output device interface 230 (shown coupled to coupled to display 20), a user input device interface 235 (shown coupled to scroll wheel 25, buttons 30, and switch 45), an I/O interface 240 (shown coupled to accessory interface connector 35 and one or more antenna(e) 245), and an optional dedicated playback engine 215′.

Embodiments of the invention can be implemented with many different types of processor. Many PMDs use an embedded processor such as processors using the ARM architecture (a RISC architecture designed by ARM Limited).

GUI engine 205, database engine 210, and playback engine 215 can be implemented, for example, in program code (software or firmware) stored in PMD 10 and running on a processor such one of processors 195, in hardware, or in combinations of the two. Database engine 210, which can be of conventional design, provides various capabilities related to searching, browsing, and selecting assets 65 or groups of assets 65 from storage subsystem 50. Playback engine 215, which can also be of conventional design, provides capabilities related to presenting selected media assets 65 from storage subsystem 50 to a user. In some embodiments, playback engine 215 may provide video portions of media assets 65 and/or audio portions of media assets 65 to the user. In some embodiments, the playback engine can provide USB digital audio as well as analog audio.

FIG. 13 shows dedicated playback engine 215′; while the playback functionality can be implemented in software by processor(s) 195, as described above, some embodiments may have a dedicated playback engine coupled to audio out connector 40. Dedicated playback engine 215′ provides decoding of encoded audio files (e.g., MP3, AAC) and digital-to-analog conversion for output at audio out connector 40. For a specific embodiment where the analog audio out signal is provided to accessories through accessory interface connector 35, the playback engine is also coupled to accessory interface connector 35. Conversely, for embodiments where there is no dedicated playback engine, I/O interface 240 can be provided with digital-to-analog conversion capability to drive audio out connector 40.

Storage subsystem 50 can include various types of storage media, and stores the basic programming and data constructs that provide at least some of the functionality of PMD 10 For example, the various program modules and databases implementing the functionality of the PMD may be stored in storage subsystem 50. The software modules are generally executed by processor(s) 195. In the case of a PMD, the storage subsystem is used to store media asset data structure 55 (media assets 65 and metadata 70), which may account for a significant portion of the overall storage capacity. In embodiments of the present invention, the storage subsystem is also used to store scrolling data structure 60 (list items 75 and friction information 80).

Memory subsystem 220 typically includes a number of memories including a main random access memory (RAM) 250 for storage of instructions and data during program execution and a non-volatile memory (NVM) 255 in which fixed instructions and fixed system parameters are stored. While the non-volatile memory may be a ROM, rewritable non-volatile memories such as flash EPROMs may be used.

File storage subsystem 225 provides persistent (non-volatile) storage for program and data files, and may include one or hard disk drives and/or flash memory drives. Additionally the file storage subsystem may support associated removable media 260, e.g., flash memory cards such as those used in digital cameras and mobile phones. Possible types of flash memory cards include but are not limited to Secure Digital (SD), CompactFlash (CF), Memory Stick (MS), MultiMediaCard (MMC) xD-Picture Card (xD), and SmartMedia (SM).

In some embodiments, some of the media assets, or portions thereof that are stored in file storage subsystem 225 are transferred to a cache in memory subsystem 220, and then read out from the cache by playback engine 215. Transferring significant portions of a media stream to memory before playback can provide a measure of skip protection for hard-drive-based PMDs, and also provides the benefit of allowing the disk drive to be turned off while media are read out from the memory.

I/O interface 240 operates, for wired connections, to provide output signals and receive input signals to and from connectors outside housing 15 such as accessory interface connector 35 and audio out connector 40. It operates, for wireless connections to provide output signals and receive input signals by use of antenna(e) 245. A number of accessories 265, designated Accessory(1) . . . . Accessory(Q) are shown coupled to the I/O interface. Accessories 265 can provide additional functionality, and can include such items as earphones, external speakers, microphones, car stereo adapters, wireless adapters, and the like.

I/O interface 240 may include one or more peripheral interfaces such as USB, IEEE 1394 (Firewire), and Bluetooth (a short-range wireless communication standard developed by the Bluetooth SIG and licensed under the trademark Bluetooth®). The I/O interface may also or alternatively include one or more wired networking interfaces (e.g., Ethernet) or wireless networking interfaces (e.g., Wi-Fi adhering to one of the 802.11 family standards, digital mobile phone technologies). Thus, depending on the embodiment, I/O interface 240 can provide an interface to one or more host computers, one or more networks, or accessories coupled to PMD 10. The I/O subsystem need not be configured for all these possibilities; it can be very limited in scope for some embodiments.

For example, the I/O subsystem of some embodiments may have the ability to couple PMD 10 to a host computer (via a wired or wireless connection) that provides additional asset management capabilities as can be provided by an MMA. Such asset management capabilities include but are not limited to storing additional assets 65 in storage subsystem 50, removing assets 65 from storage subsystem 50 and/or organizing assets in manners that facilitate desired uses. For example, music assets can be arranged into playlists.

As another example, the I/O subsystem of some embodiments (possibly the same as those above, but possibly different embodiments) will have the ability to couple PMD 10 with a source of media assets (e.g., via a wireless connection to the Internet) so that the PMD can obtain media assets without connecting to a host computer. As another example, the I/O subsystem of some embodiments (possibly the same as those above, but possibly different embodiments) will have the ability to couple PMD 10 to accessories that expand the capabilities of the PMD (e.g., via accessory interface connector 35 or antenna(e) 245).

As another example, the I/O subsystem of some embodiments (possibly the same as those above, but possibly different embodiments) will have the ability to couple PMD 10 to sources of wireless signals that allow the PMD to determine its location. Wireless signals from global positioning satellites can be used for those PMDs that include a GPS receiver. Alternatively, wireless signals from one or more cellular towers can be used by those PMDs that had the ability to triangulate or otherwise decode such signals.

In addition to, or instead of, scroll wheel 25 and buttons 30, the user input devices coupled to user input device interface 235 may include one or more of any or all of the following: keyboards; pointing devices such as mice, trackballs, touchpads, or graphics tablets; scanners, barcode scanners; touchscreens incorporated into displays; audio input devices such as voice recognition systems, microphones, and other types of input devices. In general, use of the term “user input device” is intended to include all possible types of devices and ways for a user to input information into PMD 10. This can include, for example, voice control modules, which would require a microphone (not shown) It is noted that some of the above-mentioned user input devices can be coupled to I/O interface 240 through accessory interface connector 35.

Additional types of input devices could be motion detectors such as accelerometers that can respond to a user's actually moving the device. In the case of a portable device, for example, a clockwise (or counterclockwise) twist of the wrist can be interpreted in a manner analogous to a clockwise (or counterclockwise) actuation of a scroll wheel or a knob, or can be interpreted as a flick. Similarly, while the exemplary input devices were generally described as being mounted to or associated with the PMD or computer, reference to exemplary input devices should be considered to include such devices mounted to or associated with a remote control device. Remote control devices can include wired (tethered) devices (e.g., connected to user input device interface 235 or I/O interface 240, possibly using the accessory connector) and wireless devices communicating via one of antenna(e) 245.

In FIG. 13, the only user output device coupled to user output device interface 230 is a display. The present invention does not rely on any particular type of display, although suitable candidates can include liquid crystal displays (LCDs) or light emitting diode (LED) displays. Some PMDs can also provide non-visual display such as audio output. In general, use of the term “user output device” is intended to include all possible types of devices and ways to output information from PMD 10 to a user. In typical PMDs, the primary display is a visual display, which is used to display visual characteristics of the media assets (e.g., in the case of videos, images, and the like) and metadata (perhaps displayed in lists or in hierarchical menus).

GUI engine 205 can interact with display 20 and user input devices such as scroll wheel 25 and buttons 30 to provide a graphical user interface, allowing a user to control operation of PMD 10. GUI engine 205 can control display 20 to present user interface elements such as text menus, icons or the like, and user input devices can be operated by a user to interact with the displayed user interface elements (e.g., selecting or activating an element, thereby giving an instruction to PMD 10).

In some embodiments, user input devices can include a touch-sensitive element overlaying display 20, providing a touch screen interface. In other embodiments, user input devices can include distinct devices such as one or more of a scroll wheel 25, buttons 30, a touch pad. In any event, GUI engine 205 can reflect the operation of user input device(s) by updating display 20, e.g., to change which item on a menu is highlighted for selection. The GUI can enable the user to control any aspect of PMD 10, including locating and selecting media assets 65 to be played, controlling playback (e.g., play, pause, fast forward, rewind, etc.), adjusting playback settings (volume, equalizer, etc.), and so on. Scrolling engine 100, shown as a separate element in FIG. 4, can be integrated into GUI engine 205.

A significant aspect of the user input is the functionality of allowing the user to access the assets, such as the music or words of audio tracks, and the images and soundtrack of pictures and videos. As such, some of the embodiments of the invention are concerned with facilitating the scrolling in connection with accessing assets efficiently.

In conclusion can be seen that embodiments of the present invention provide additional functionality that can enhance user experience and convenience when scrolling lists, especially long lists.

While the above is a complete description of specific embodiments of the invention, the above description should not be taken as limiting the scope of the invention as defined by the claims.

1. A method of controlling the display of a list of items in response to a scrolling request, the method comprising:
converting the scrolling request to a scrolling control signal using a default mapping so that items on the list move relative to a reference position with a speed profile and direction determined by the default mapping; and
in response to determining that a given item on the list has friction and that the given item and the reference position satisfy a proximity constraint, overriding the default mapping and converting the scrolling request to a scrolling control signal using an override mapping so that items on the list move relative to the reference position with a lower speed than otherwise specified by the default mapping.

2. The method of claim 1 wherein overriding the default mapping includes pausing scrolling when the given item is at the reference position or at a position offset from the reference position.

3. The method of claim 2 wherein overriding the default mapping includes slowing scrolling at least before or after pausing scrolling.

4. The method of claim 1 wherein the reference position is defined by the leading edge of a viewport.

5. The method of claim 4 wherein:
the proximity constraint is that the given item be at the leading edge of the viewport or within the viewport;
whereupon the default mapping is first overridden when the given item enters the viewport and scrolling reverts to using the default mapping when the given item leaves the viewport.

6-8. (canceled)

9. The method of claim 1 wherein the reference position is defined by a cursor location.

10. The method of claim 9 wherein the proximity constraint is that the given item be within a predetermined range that includes positions leading up to the cursor and positions past the cursor.

11. The method of claim 1 wherein the scrolling request results from user input provided by one of a gesture on a capacitive sensor, actuation of a movable element, an interaction with a displayed control element.

12. (canceled)

13. A method of controlling the display of a list of items in response to a scrolling request, the method comprising:
converting the scrolling request to a scrolling control signal using a default mapping so that items on the list move relative to a cursor position with a speed profile and direction determined by the default mapping; and
in response to determining that a given item on the list has friction and that the given item is at or near the cursor position, overriding the default mapping and converting the scrolling request to a scrolling control signal using an override mapping so that items on the list move relative to the cursor position with a lower speed than otherwise specified by the default mapping.

14-15. (canceled)

16. A method of controlling the display of a list of items in response to a scrolling request, the method comprising:
converting the scrolling request to a scrolling control signal using a default mapping so that items on the list move relative to a viewport with a speed profile and direction determined by the default mapping; and
in response to determining that a given item on the list has friction and that the given item appears in the viewport or is about to appear in the viewport, overriding the default mapping and converting the scrolling request to a scrolling control signal using an override mapping so that items on the list move relative to the cursor position with a lower speed than otherwise specified by the default mapping.

17. The method of claim 16 wherein overriding the default mapping includes pausing scrolling when the given item is in the viewport.

18. The method of claim 17 wherein overriding the default mapping includes slowing scrolling at least before or after pausing scrolling.

19. The method of claim 16 wherein the default mapping is overridden so that the given item remains in the viewport for at least a predetermined time before relative movement resumes according to the default mapping.

20. The method of claim 16 wherein the default mapping is overridden so that the given item is paused in the viewport for at least a predetermined time before relative movement resumes according to the default mapping.

21. The method of claim 16 wherein the default mapping is overridden so that the given item moves at a significantly reduced speed across at least a portion of the viewport before relative movement resumes according to the default mapping.

22. The method of claim 16 wherein the speed profile is overridden so that the given item's speed is reduced when the given item first appears in the viewport.

23. The method of claim 16 wherein the default mapping is overridden so that:
the speed of items in the viewport is reduced before the given item first appears in the viewport; and
relative movement resumes according to the default mapping after the given item has remained in the viewport for at least a predetermined time.

24. The method of claim 16, and further comprising changing the appearance of the given item relative to adjacent items.

25. The method of claim 24 wherein changing the appearance of the given item includes at least one of leaving additional space between the given item and one or more adjacent items, putting a border around the given item, changing a text style of the given item, applying an animation feature to the given item, or providing a 3-D aspect for the given item.

26. The method of claim 16, and further comprising displaying additional information regarding the given item, either instead of or in addition to, information that is displayed for other items on the list.

27-28. (canceled)

29. A portable device comprising:
a storage medium;
a processor coupled to said storage medium;
a user interface element operable by a user to provide signals representing scrolling requests; and
computer code stored in said storage medium wherein said computer code, when retrieved from said storage medium and executed by said processor, results in:
displaying a list of items;
converting the scrolling request to a scrolling control signal using a default mapping so that items on the list move relative to a reference position with a speed profile and direction determined by the default mapping; and
in response to determining that a given item on the list has friction and that the given item and the reference position satisfy a proximity constraint, overriding the default mapping and converting the scrolling request to a scrolling control signal using an override mapping so that items on the list move relative to the reference position with a lower speed than otherwise specified by the default mapping.

30. The portable device of claim 29 wherein overriding the default mapping includes pausing scrolling when the given item is at the reference position or at a position offset from the reference position.

31. The portable device of claim 29 wherein the reference position is defined by the leading edge of a viewport.

32. The portable device of claim 29 wherein the reference position is defined by a cursor location.

33. Apparatus for controlling the display of a list of items in response to a scrolling request, the apparatus comprising:
a user interface element operable by a user to provide signals representing scrolling requests;
a list display engine for displaying a list and moving the list relative to a reference position in response to a scrolling control signal; and
a scrolling engine, responsive to scrolling requests, for converting a scrolling request to a scrolling control signal, the scrolling engine configured to:
convert the scrolling request to a scrolling control signal using a default mapping so that items on the list move relative to a reference position with a speed profile and direction determined by the default mapping; and
in response to determining that a given item on the list has friction and that the given item and the reference position satisfy a proximity constraint, override the default mapping and convert the scrolling request to a scrolling control signal using an override mapping so that items on the list move relative to the reference position with a lower speed than otherwise specified by the default mapping.

34. The apparatus of claim 33 wherein the reference position is defined by the leading edge of a viewport.

35. The apparatus of claim 33 wherein the reference position is defined by a cursor location.

36. The apparatus of claim 33 wherein overriding the default mapping includes pausing scrolling when the given item is at the reference position or at a position offset from the reference position.

37. The apparatus of claim 36 wherein overriding the default mapping includes slowing scrolling at least before or after pausing scrolling.

38. A computer-readable medium containing program instructions, which when executed by a computer system in a portable device cause the computer system to execute a method of controlling the scrolling of a list of items on an output device wherein user input requesting scrolling, referred to as a scrolling request, is converted to a scrolling control signal, the method comprising:
in response to the scrolling request, scrolling through the list so that items on the list move relative to a reference position with a speed profile and direction determined by a default mapping of the scrolling request, at least some items on the list moving toward, and then past the reference position;
determining that a given item on the list has friction; and
overriding the default mapping when the given item and the reference position satisfy a proximity constraint so that scrolling occurs with a lower speed than otherwise specified by the speed profile.

39-41. (canceled)
